(19) United States
(12) Patent Application Publication
(10) Pub. No.: US 2003/0079572 A1
(43) Pub. Date: May 1, 2003

(54) Spanner

(76) Inventor: Shya-Song Ho, Taichung City (TW)

Correspondence Address: John F. Gulbin, Pitney, Hardin, Kipp & Szuch LLP, 20th Floor, 711 Third Avenue, New York, NY, 10017, US

(21) Appl. No.: 09/999,319

(22) Filed: Oct. 31, 2001

(51) Int. Cl. B25B 13/46

(52) U.S. Cl. 81/63.2

(57) ABSTRACT

A spanner includes a socket disposed rotatably in an outer wall defined by a head portion of an operating lever. The operating lever includes a neck portion defining a wheel-retention recess. A cam wheel is pivotally disposed in the wheel-retention recess, and constantly engages a recess-confining wall that defines the wheel-retention recess. The cam wheel is turnable in the wheel-retention recess, and has at least one engaging portion which moves toward and engages the socket when the cam wheel turns in a first direction, and a non-engaging portion which moves toward and disengages from the socket when the cam wheel turns in a second direction opposite to the first direction.

### BACKGROUND OF THE INVENTION

1. Field of the Invention

The present invention relates to a spanner, more particularly to a spanner which includes components that can be easily manufactured without requiring high precision and complicated techniques.

2. Description of the Related Art

Referring to FIG. 1, a conventional ratchet spanner is shown to include a spanner body 1 and a ratchet mechanism. The spanner body 1 has an annular head portion 11 defining a ratchet accommodating chamber 110. The ratchet mechanism includes a ratchet wheel 12 disposed rotatably in the chamber 110, and a spring-biased pawl unit (not shown) which operably engages one of the teeth 121 formed on an outer circumferential wall surface of the ratchet wheel 12 so as to permit synchronous rotation of the ratchet wheel 12 and the spanner body 1 when the latter turns in a first direction, and idle rotation of the spanner body 1 with respect to the ratchet wheel 12 when the spanner body 1 turns in a second direction opposite to the first direction. The inner peripheral wall surface 122 of the ratchet wheel has a polygonal cross-section in order to receive the head of a bolt therein.

Some of the drawbacks of the aforementioned conventional ratchet spanner are as follows:

It is relatively difficult to manufacture the components of the aforesaid ratchet spanner. Because there are seventy two densely located fine profile teeth 121 on the ratchet wheel 12, adjacent sides of each of the teeth 121 are formed with a backlash angle of 5 degrees. As such, a relatively high precision technique and great skill are required to produce the ratchet wheel 12, thereby resulting in a high manufacturing cost and long production time.

### SUMMARY OF THE INVENTION

Therefore, the object of this invention is to provide a spanner which includes components that are easily manufactured and that can be easily assembled.

Accordingly, a spanner of the present invention includes an operating lever, a socket, a transmission cam wheel, and a positioning unit. The operating lever has a head portion, an elongated operating portion, and a neck portion interposed between and interconnecting the head and operating portions. The head portion includes an annular outer wall which defines a receiving space. The neck portion defines a wheel-retention recess which is confined by a recess-confining wall and which is in spatial communication with the receiving space. The socket is disposed in the receiving space, and includes an annular inner wall that is surrounded by the outer wall. The cam wheel is disposed pivotally in the wheel-retention recess about a pivot axis, and has an outer periphery which is in constant engagement with the recess-confining wall. The outer periphery of the cam wheel has at least one engaging portion engageable with the inner wall, and a non-engaging portion which extends from the engaging portion and which is disengageable from the inner wall. The cam wheel is turnable within the wheel-retention recess in a first direction from a disengaging position to an engaging position, in which the engaging portion moves toward and engages the inner wall while the non-engaging portion moves away from the inner wall so as to permit synchronous turning of the socket and the operating lever in the first direction, and in a second direction opposite to the first direction from the engaging position to the disengaging position, in which the engaging portion moves away and disengages from the inner wall while the non-engaging portion moves toward the inner wall so as to permit idle rotation of the operating lever in the second direction relative to the socket. The positioning unit positions the cam wheel at the engaging position.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a partly cutaway fragmentary perspective view of a conventional ratchet spanner;

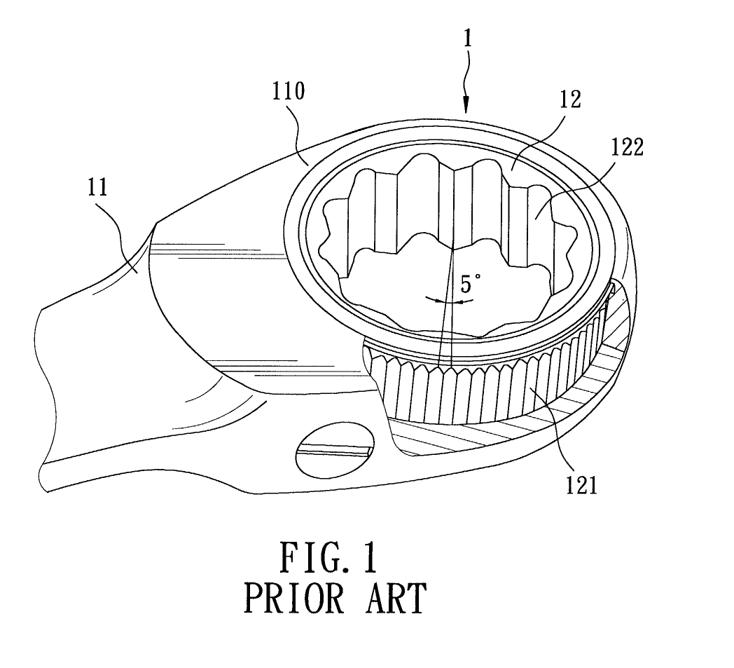

FIG. 2 is a perspective view of a first preferred embodiment of a spanner according to the present invention;

FIG. 3 is a partly exploded view of the first preferred embodiment;

FIG. 4 is a partly sectional schematic side view of the first preferred embodiment, illustrating how an inner wall is prevented from removal from an outer wall defined by an operating lever;

FIG. 5 is a fragmentary schematic top view of the first preferred embodiment, illustrating a first mode where the operating lever and the inner wall are synchronously turnable in a first direction;

FIG. 6 is a fragmentary schematic top view of the first preferred embodiment, illustrating a second mode where the operating lever and the inner wall are synchronously turnable in a second direction opposite to the first direction;

FIG. 7 is a fragmentary schematic top view of a second preferred embodiment, illustrating how the operating lever and the inner wall are synchronously turnable in the second direction;

FIG. 8 is a partly exploded view of a third preferred embodiment of the present invention; and

FIG. 9 is a fragmentary schematic top view of the third preferred embodiment, illustrating how the operating lever and the inner wall are synchronously turnable in the second direction.

### DETAILED DESCRIPTION OF THE PREFERRED EMBODIMENTS

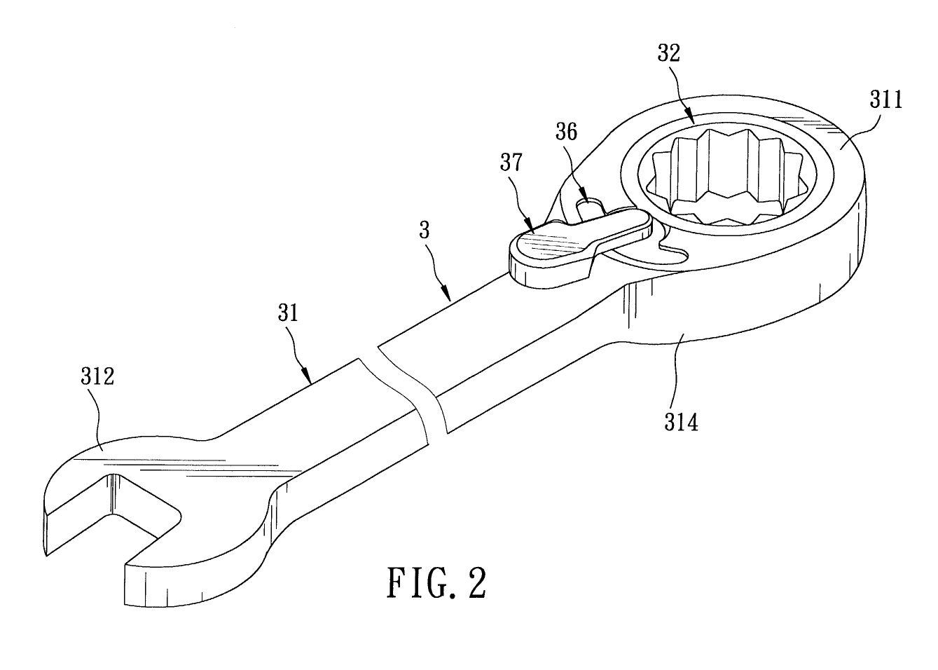

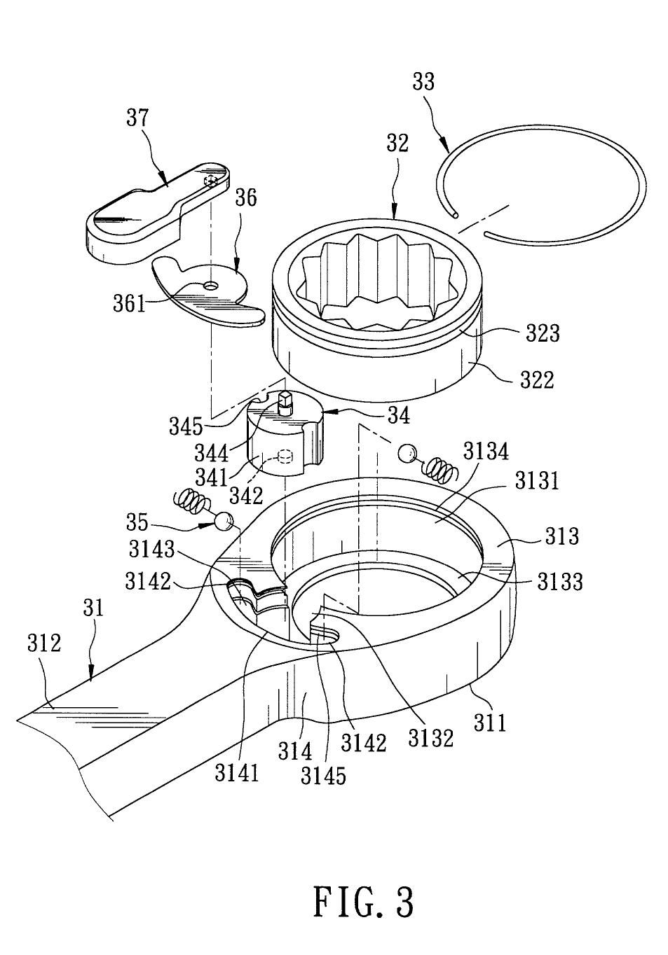

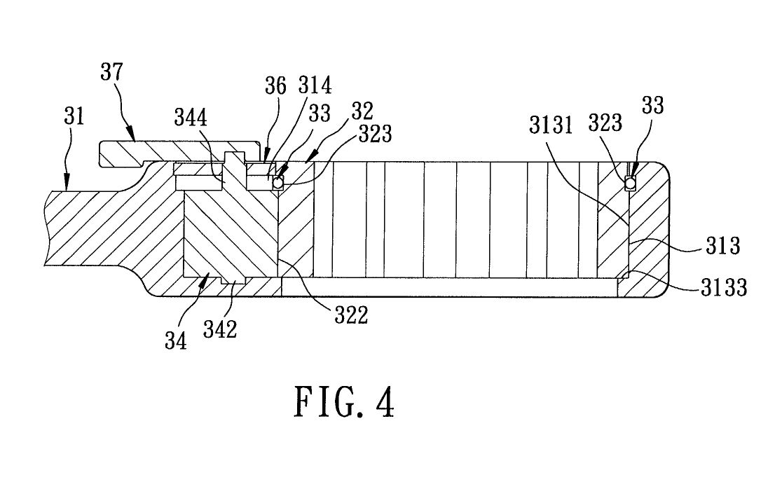

Referring to FIGS. 2, 3 and 4, the first preferred embodiment of a spanner 3 according to the present invention is shown to include an operating lever 31, a socket 32, a transmission cam wheel 34, and a positioning unit.

As illustrated, the operating lever 31 has a head portion 311, an elongated operating portion 312, and a neck portion 314 interposed between and interconnecting the head and neck portions 311,314. The head portion 311 includes an annular outer wall 313 with top and bottom ends, and a bottom flange 3133 which extends inwardly from the bottom end and which has an annular inner peripheral wall surface defining a bottom opening. A slot 3132 is formed in the outer wall 313. The outer wall 313 defines a receiving space 3131 therein. The neck portion 314 defines a wheel-retention recess 3143 which is confined by a recess-confining wall 3141 and which is in spatial communication with the receiving space 3131 via the slot 3132.

The socket 32 is disposed rotatably in the receiving space 3131, and includes an annular inner wall 322 that is disposed on the bottom flange 3133 of the head portion 311 so as to prevent downward removal of the socket 32 from the outer wall 313. The outer wall 313 is further formed with a ring-retention groove 3134. The inner wall 322 is surrounded by the outer wall 311, and is formed with a ring-retention groove 323 which is aligned with the ring-retention groove 3134 in the outer wall 313 to receive a C-shaped retaining ring 33, thereby retaining the socket 32 in the receiving space 3131.

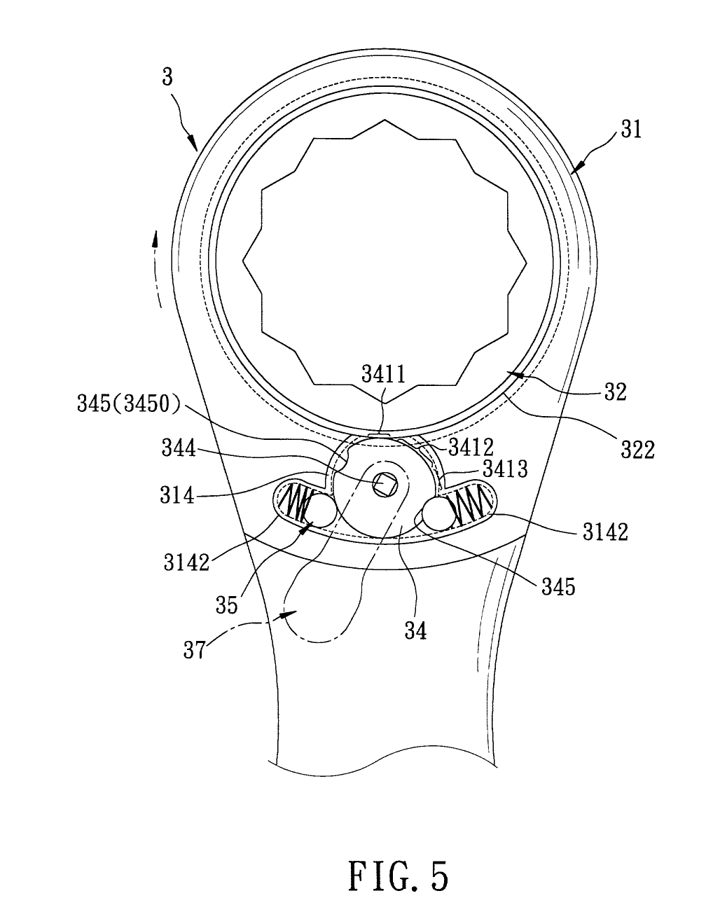

The transmission cam wheel 34 is disposed pivotally in the wheel-retention recess 3143 about the axis of a pivot 342, and has an outer periphery 341 which is in constant engagement with the recess-confining wall 3141. The outer periphery 341 of the cam wheel 34 has at least one engaging portion 3411 engageable with the inner wall 322, and a non-engaging portion 3412 which extends from the engaging portion 3411 and which is disengageable from the inner wall 322. The cam wheel 34 is limitedly turnable within the wheel-retention recess 3143 in a first direction (shown by the arrow head in FIG. 5) from a disengaging position to an engaging position, in which the engaging portion 3411 moves toward and engages the inner wall 322 while the non-engaging portion 3412 moves away from the inner wall 322 so as to permit synchronous turning of the socket 32 and the operating lever 31 in the first direction, as best shown in FIG. 5. The cam wheel 34 is further turnable within the wheel-retention recess 3143 in a second direction opposite to the first direction from the engaging position to the disengaging position, in which the engaging portion 3411 moves away and disengages from the inner wall 322 while the non-engaging portion 3412 moves toward the inner wall 322 so as to permit idle rotation of the operating lever 31 in the second direction relative to the socket 32.

The cam wheel 34 is further formed with opposing left and right curved grooves 345 in the outer periphery 341. The left and right curved grooves 345 are respectively defined by left and right groove-confining walls 3450 (see FIG. 5). Preferably, the outer periphery 341 of the cam wheel 34 has left and right engaging portions 3411,3413 which are spaced apart by the non-engaging portion 3412 and which respectively extend from adjacent ends of the left and right groove-confining walls 3450 to the non-engaging portion 3412. The neck portion 314 of the operating lever 31 further defines opposing left and right spring recesses 3142 that extend outwardly and oppositely from and that are in spatial communication with the wheel-retention recess 3143.

In this embodiment, the positioning unit includes left and right spring-biased balls 35 respectively received in the left and right spring recesses 3142 and respectively engageable with the left and right curved grooves 345 in a tongue-and-groove manner.

A cam-wheel actuator 37 is connected to a connecting end 344 of the cam wheel 34 for manually turning the same between first and second modes. When the cam wheel 34 is turned about the pivot 342 to the first mode, as shown in FIG. 5, the right spring-biased ball 35 is received in the right curved groove 345 while the left spring-biased ball 35 disengages from the left curved groove 345. The left engaging portion 3411 of the cam wheel 34 engages the inner wall 322 so as to permit synchronous turning of the socket 32 and the operating lever 31 in the first direction (clockwise direction), and so as to permit idle rotation of the operating lever 31 in the second direction (counterclockwise direction) relative to the socket 32.

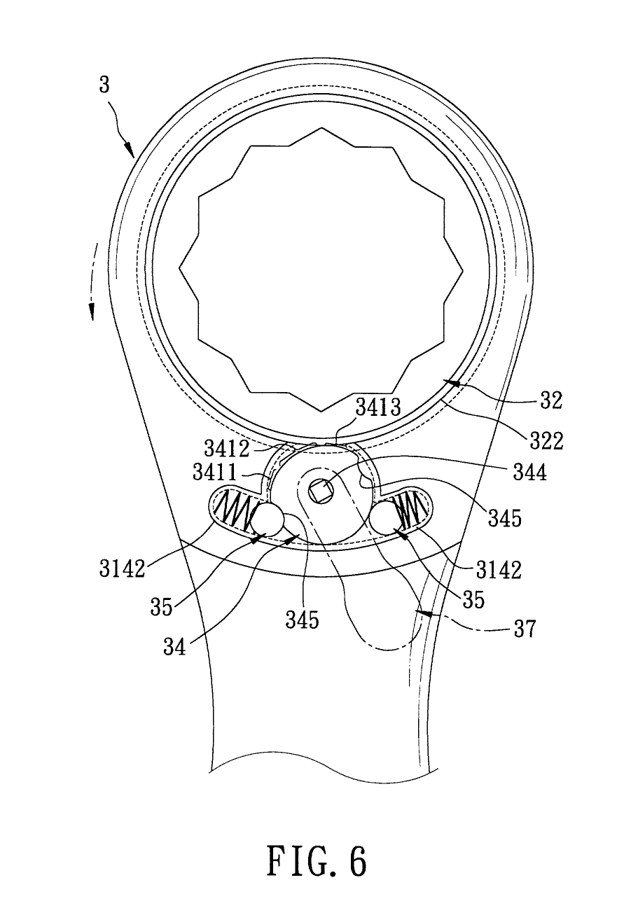

When the cam wheel 34 is turned about the pivot 342 to the second mode, as best shown in FIG. 6, the left spring-biased ball 35 is received in the left curved groove 345 while the right spring-biased ball 35 disengages from the right curved groove 345. Under this condition, the right engaging portion 3413 engages the inner wall 322 so as to permit synchronous turning of the socket 32 and the operating lever 31 in the second direction (counterclockwise direction) and so as to permit idle rotation of the operating lever 31 in the first direction (clockwise direction) relative to the socket 32.

A cover retaining groove 3145 is formed along a periphery of the wheel-retention recess 3143, a periphery of the left and right spring recesses 3142, and a periphery of the slot 3132 for receiving a cam cover 36. Under this condition, upward removal of the cam wheel 34 from the wheel-retention recess 314 is prevented. The cam cover 36 is formed with a through hole 361 to permit extension of the connecting end 344 of the cam wheel 34 for coupling with the cam-wheel actuator 37.

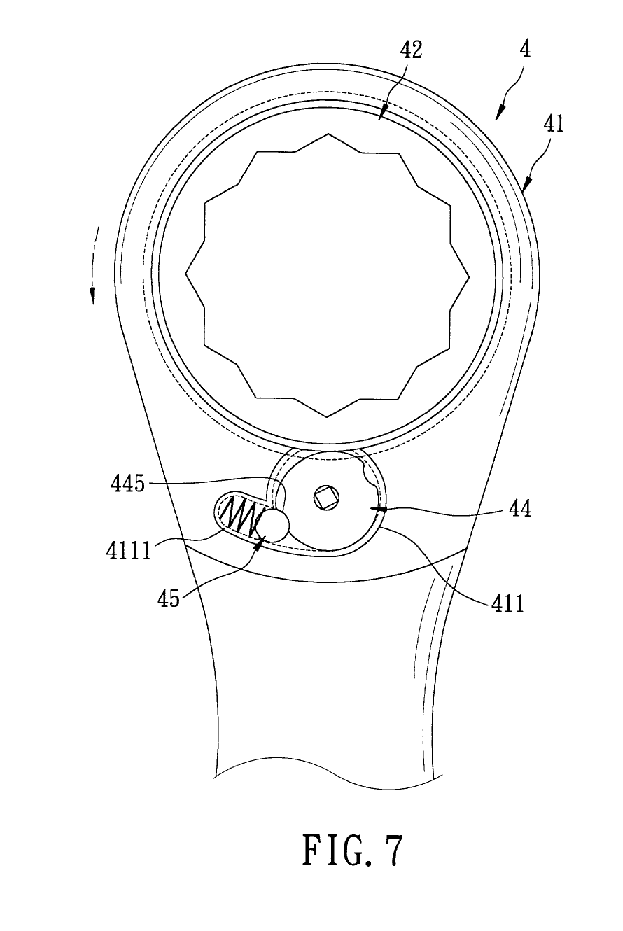

Referring to FIG. 7, the second preferred embodiment of a spanner 4 according to the present invention is shown to be similar to the first preferred embodiment in structure, except that the neck portion of the operating lever 41 defines a spring recess 4111 which extends outwardly from and which is in spatial communication with the wheel-retention recess 411. The positioning unit includes only one spring-biased ball 45 that is disposed in the spring recess 4111 and that has an engaging portion extendible into one of two curved grooves 445 of the cam wheel 44 so as to position the latter at the engaging position. In the second preferred embodiment, the operating lever 41 and the socket 42 turns synchronously in the counterclockwise direction. The operating lever 41 turns idly relative to the socket 42 in the clockwise direction.

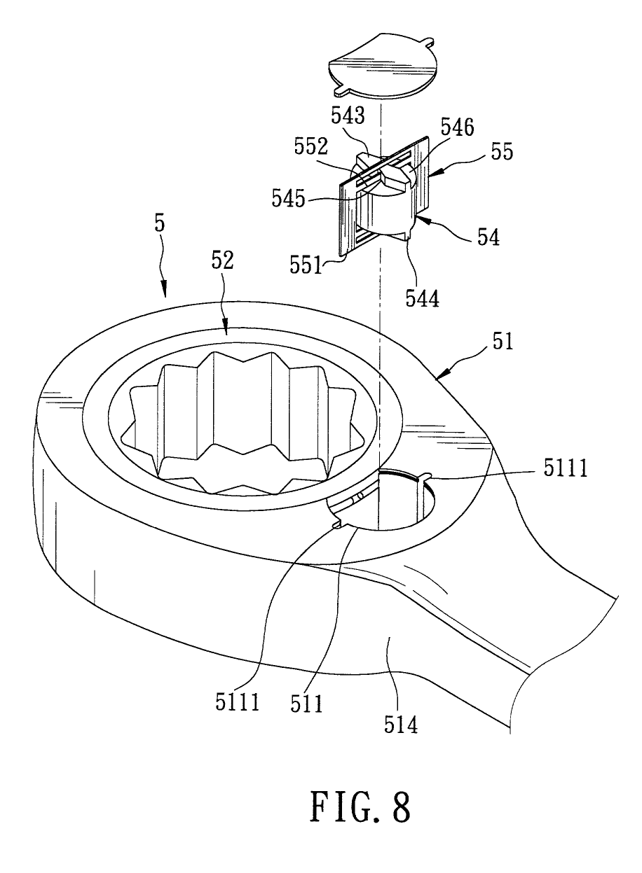

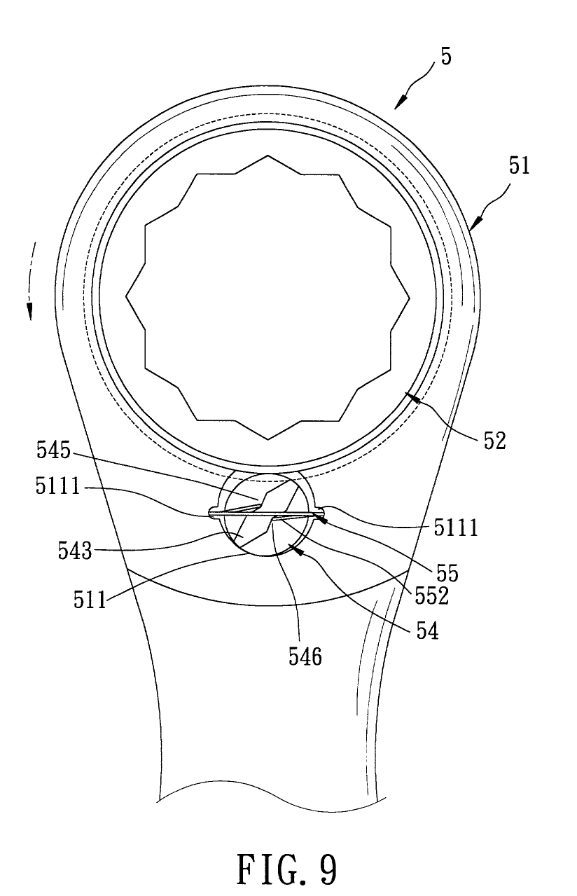

Referring to FIG. 8, the third preferred embodiment of a spanner 5 according to the present invention is shown, in which, the neck portion 514 of the operating lever 51 defines opposite left and right frame-holding recesses 5111 that extend oppositely from and that are in spatial communication with the wheel-retention recess 511 and that extend in a direction transverse to a longitudinal length of the operating lever 51. The cam wheel 54 has top and bottom protrusions 543,544, each of which defines opposing left and right positioning grooves 545,546. A wheel-holding frame 55 has left and right frame portions 551 respectively inserted in the frame-holding recesses 5111, and upper and lower frame portions which extend between the left and right frame portions 551 to define a frame space which permits extension of the cam wheel 54 therethrough in a transverse direction relative to the wheel-holding frame 55. Left and right spring arms 552 respectively extend from the left and right frame portions 551 of the wheel-holding frame 55 and respectively have left and right free ends which extend into the left and right positioning grooves 545,546 in the top and bottom protrusions 543,544 to abut against the latter and which are offset from each other in the transverse direction at two opposite sides of the wheel-holding frame 55 so as to position the cam wheel 34 at the engaging position, as best shown in FIG. 9. Under such a condition, the operating lever 51 and the socket 52 synchronously turn in the counterclockwise direction to perform a tightening operation. The operating lever 51 turns idly relative to the socket 52 in the clockwise direction.

The advantages that result from the use of the spanner 3,4,5 of this invention are as follows:

Note that the inner wall of the socket 32,42,52 is not formed with engaging teeth, and can thus be manufactured easily without involving complicated processes, thereby resulting in fewer working time and lower production costs as compared to the conventional spanner.

No high precision technique is required to produce the cam wheel 34,44, 54 of the spanner of the present invention, thereby avoiding the backlash problems encountered during the manufacturing process of the conventional spanner.

With this invention thus explained, it is apparent that numerous modifications and variations can be made without departing from the scope and spirit of this invention. It is therefore intended that the invention be limited only as indicated in the appended claims.

I claim:

1. A spanner comprising:
an operating lever having a head portion, an elongated operating portion, and a neck portion interposed between and interconnecting said head and operating portions, said head portion including an annular outer wall that defines a receiving space, said neck portion defining a wheel-retention recess which is confined by a recess-confining wall and which is in spatial communication with said receiving space;
a socket disposed in said receiving space, and including an annular inner wall that is surrounded by said outer wall;
a transmission cam wheel disposed pivotally in said wheel-retention recess about a pivot axis, and having an outer periphery which is in constant engagement with said recess-confining wall, said outer periphery having at least one engaging portion engageable with said inner wall, and a non-engaging portion extending from said engaging portion and disengageable from said inner wall, said cam wheel being turnable in a first direction from a disengaging position to an engaging position, in which said engaging portion moves toward and engages said inner wall while said non-engaging portion moves away from said inner wall so as to permit synchronous turning of said socket and said operating lever in said first direction, and in a second direction opposite to said first direction from said engaging position to said disengaging position, in which said engaging portion moves away and disengages from said inner wall while said non-engaging portion moves toward said inner wall so as to permit idle rotation of said operating lever in said second direction relative to said socket; and
a positioning unit for positioning said cam wheel at said engaging position.

2. The spanner as defined in claim 1, wherein said cam wheel is formed with a curved groove in said outer periphery, said neck portion further defining a spring recess that extends outwardly from and that is in spatial communication with said wheel-retention recess, said positioning unit including a spring-biased ball that is received in said spring recess and that has an engaging portion extendible into said curved groove so as to position said cam wheel at said engaging position.

3. The spanner as defined in claim 1, wherein said cam wheel is formed with opposing left and right curved grooves in said outer periphery, said left and right curved grooves being respectively defined by left and right groove-confining walls, said outer periphery having left and right ones of said engaging portions spaced apart by said non-engaging portion and respectively extending from adjacent ends of said left and right groove-confining walls to said non-engaging portion, said neck portion further defining two opposite left and right spring recesses that extend outwardly and oppositely from and that are in spatial communication with said wheel-retention recess, said positioning unit including left and right spring-biased balls respectively received in said left and right spring recesses and respectively engageable with said left and right curved grooves, said cam wheel being turnable about said pivot axis between first and second modes, wherein,
in said first mode, said right spring-biased ball is received in said right curved groove while said left spring-biased ball disengages from said left curved groove, and said left one of said engaging portions engages said inner wall so as to permit synchronous turning of said socket and said operating lever in said first direction and idle rotation of said operating lever in said second direction relative to said socket, and
in said second mode, said left spring-biased ball is received in said left curved groove while said right spring-biased ball disengages from said right curved groove, and said right one of said engaging portions engages said inner wall so as to permit synchronous turning of said socket and said operating lever in said second direction and idle rotation of said operating lever in said first direction relative to said socket.

4. The spanner as defined in claim 3, further comprising a cam-wheel actuator connected to said cam wheel for manually turning said cam wheel to a selected one of said first and second modes.

5. The spanner as defined in claim 1, wherein said neck portion further defines opposite left and right frame-holding recesses that extend oppositely from and that are in spatial communication with said wheel-retention recess and that extend in a direction transverse to a longitudinal length of said operating lever, said cam wheel having top and bottom protrusions, each of which defines opposing left and right positioning grooves, said positioning unit including a wheel-holding frame that has left and right frame portions respectively inserted in said frame-holding recesses and that defines a frame space which permits extension of said cam wheel therethrough in a transverse direction relative to said wheel-holding frame, said wheel-holding frame further having left and right spring arms that respectively extend from said left and right frame portions and that respectively have left and right free ends which extend into said left and right positioning grooves in said top and bottom protrusions, and which are offset from each other in said transverse direction, and which are disposed at two opposite sides of said wheel-holding frame to abut against said top and bottom protrusions so as to position said cam wheel at said engaging position.
